(19) United States
(12) Patent Application Publication
(10) Pub. No.: US 2014/0272482 A1
(43) Pub. Date: Sep. 18, 2014

(54) ELECTROLYTE PROTECTION COMPOSITIONS AND METHODS

(71) Applicant: UNIENERGY TECHNOLOGIES, LLC, Mukilteo, WA (US)

(72) Inventors: Liyu Li, Richland, WA (US); Chenxi Sun, Seattle, WA (US); Jinfeng Wu, Mukilteo, WA (US)

(73) Assignee: UNIENERGY TECHNOLOGIES, LLC, Mukilteo, WA (US)

(21) Appl. No.: 14/214,373

(22) Filed: Mar. 14, 2014

Related U.S. Application Data
(60) Provisional application No. 61/794,890, filed on Mar. 15, 2013.

(51) Int. Cl. H01M 8/18; H01M 8/20

(52) U.S. Cl. CPC H01M 8/188; H01M 8/20
USPC 429/50; 429/105; 429/107

(57) ABSTRACT

A barrier on the surface of the negative electrolyte solution of a redox flow battery can decrease air oxidation of a charged species in the negative electrolyte solution and can decrease water loss from the negative electrolyte solution. A negative electrolyte tank including a barrier on the surface of the negative electrolyte can have many advantages, including simplified setup, low cost, and low maintenance.

### CROSS-REFERENCE TO RELATED APPLICATION

This application claims the benefit of Provisional Patent Application No. 61/794,890, filed Mar. 15, 2013, the entire disclosure of which is incorporated herein by reference.

### BACKGROUND

Concerns over the environmental consequences of burning fossil fuels have led to an increasing use of renewable energy generated from sources such as solar and wind. The intermittent and varied nature of such renewable energy sources, however, has made it difficult to fully integrate these energy sources into electrical power grids and distribution networks. A solution to this problem has been to employ large-scale electrical energy storage (EES) systems, which systems are widely considered to be an effective approach to improve the reliability, power quality, and economy of renewable energy derived from solar or wind sources. Among the most promising large-scale EES technologies are redox flow batteries. Redox flow batteries are special electrochemical systems that can repeatedly store and convert megawatt-hours (MWhs) of electrical energy to chemical energy and chemical energy back to electrical energy when needed.

In simplified terms, an electrochemical cell is a device capable of either deriving electrical energy from chemical reactions, or facilitating chemical reactions through the introduction of electrical energy. An electrochemical cell has two half-cells. Each half-cell includes an electrode and an electrolyte. The two half-cells may use the same electrolyte, or they may use different electrolytes. In a full electrochemical cell, species from one half-cell lose electrons (oxidation) to their electrode while species from the other half-cell gain electrons (reduction) from their electrode. A plurality of electrochemical cells electrically connected together in series within a common housing is generally referred to as an electrochemical “stack.”

A redox (reduction/oxidation) flow battery is a special type of electrochemical system in which an electrolyte containing one or more dissolved electroactive species flows through a plurality of electrochemical cells. A common redox flow battery electrochemical cell configuration includes a positive electrode and a negative electrode separated by an ion exchange membrane or a separator, and two circulating electrolyte solutions (positive and negative electrolyte flowstreams generally referred to as the “catholyte” and “anolyte,” respectively). The energy conversion between electrical energy and chemical potential occurs instantly at the electrodes once the liquid electrolyte begins to flow through the cells.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter

In one aspect, this disclosure features a redox flow battery including a negative electrolyte (i.e., anolyte) tank including an anolyte having a surface, a gas atmosphere, and a liquid or solid barrier (e.g., a layer of water-immiscible oil, a polymer film, etc.) between the anolyte and the gas atmosphere. The liquid or solid barrier is in direct contact with the surface of the anolyte. In some embodiments, the liquid or solid barrier decreases access of oxygen to the anolyte and thereby decreases oxidation of a charged species in the anolyte. In these or other embodiments, the liquid or solid barrier reduces a water partial pressure inside the anolyte tank.

In another aspect, this disclosure features a redox flow battery that includes (a) an anolyte tank including an anolyte having a surface, a gas atmosphere, and a liquid or a solid barrier between the anolyte and the gas atmosphere, wherein the liquid or the solid barrier is in direct contact with the surface of the anolyte; (b) an anode in fluid communication with the anolyte tank; (c) a catholyte tank including a catholyte; (d) a cathode in fluid communication with the catholyte tank; and (e) an ion-permeable separator between the cathode and the anode.

In another aspect, this disclosure features a method of operating a redox flow battery. The method includes (a) providing a redox flow battery including an anolyte tank including an anolyte and a gas atmosphere; (b) providing a liquid or solid barrier between the anolyte and the gas atmosphere, wherein the liquid or solid barrier is in direct contact with the surface of the anolyte; and (c) operating the redox flow battery.

In yet another aspect, the disclosure features a flow electrochemical energy system that includes a negative electrolyte protection system and method. A liquid or solid barrier covers at least a portion of the surface of the negative electrolyte solution to reduce or sometimes prevent oxidation of the charged species by oxygen and reduce the water partial pressure inside the electrolyte tanks. In some embodiments, the small amount of H₂ generated in the negative electrolyte tanks is directly removed by a small stream of gas flow, resulting in a simplified gas management system for redox flow batteries.

In yet another aspect, the disclosure features a redox flow battery including a negative electrolyte tank that includes a liquid anolyte and a gas atmosphere. The anolyte is covered with a liquid or solid barrier to reduce contact of the anolyte with the gas atmosphere. In various embodiments, the battery includes one or more, in any combination, of the following features: the battery can be selected from a vanadium redox flow battery, a vanadium-halide redox flow battery, a Fe—Cr redox flow battery, and a V—Fe redox flow battery; the liquid barrier can include an oil; the oil can be an organic liquid that forms a continuous layer on the surface of the anolyte; the oil can include a mineral oil; the oil can include a silicone oil; the gas atmosphere can include air or an inert gas.

In yet another aspect, the disclosure features a process of operating a redox flow battery. In various embodiments, the battery includes a positive electrolyte tank, and a negative electrolyte tank that includes a liquid anolyte and a headspace filled with a gas atmosphere. The anolyte is covered with a liquid or solid barrier to reduce contact of the anolyte with the atmosphere. The process includes (a) operating the battery for a time sufficient to generate hydrogen in the headspace, and (b) purging the headspace (e.g., replacing the gas atmosphere in the headspace) with fresh atmosphere to remove the hydrogen from the headspace. In various embodiments, the battery includes one or more of the following features, in any combination: the battery can be selected from a vanadium redox flow battery, a vanadium-halide redox flow battery, a Fe—Cr redox flow battery, and a V—Fe redox flow battery; the liquid or solid barrier can include an oil; the oil can be an organic liquid that forms a continuous layer on the surface of the anolyte; the oil can be a mineral oil; the oil can be a silicone oil; and the purging atmosphere can include air or an inert gas.

In yet another aspect, the present disclosure features a sealing method. In this method, aimed for reducing oxidation of charged negative electrolyte solutions by oxygen, a liquid or solid barrier on the surface of negative electrolyte solutions is employed to protect the negative electrolyte solutions from oxidation over a wide temperature range and for an extended period of time. One benefit is a decreased need for inert gas purging. This protection method can be useful for negative electrolyte sampling and accurate analysis, as oxidation of charged species in the electrolyte is decreased.

Embodiments of the systems and methods of the disclosure can include one or more of the following features, in any combination.

In some embodiments, the liquid or solid barrier is employed to cover at least a portion of an interface between the anolyte and the gas atmosphere. For example, the liquid or solid barrier can cover an entire interface between the anolyte and the gas atmosphere, or a portion thereof. The liquid or solid barrier can be in the form of a layer. In some embodiments, the layer has a thickness of from 0.1 to 200 mm.

In some embodiments, the liquid or solid barrier is oxygen impermeable. In some embodiments, the liquid or solid barrier is hydrogen permeable. In some embodiments, the anolyte tank includes a liquid barrier between the anolyte and the gas atmosphere. The liquid barrier can include an oil (e.g., an inorganic or an organic oil, etc.). The oil can be saturated and/or non-reactive. In some embodiments, the oil is selected from the group consisting of silicone oil and mineral oil.

In some embodiments, the redox flow battery further includes a catholyte tank that includes a catholyte and a catholyte tank gas atmosphere, wherein the catholyte tank does not include a liquid or solid barrier. In some embodiments, the catholyte tank includes a liquid or solid barrier that is the same, or different from the liquid or solid barrier in the anolyte tank. In some embodiments, the liquid or solid barrier in the catholyte tank is employed to cover at least a portion of an interface between the catholyte and the catholyte tank gas atmosphere. For example, the liquid or solid barrier in the catholyte tank can cover an entire interface between the catholyte and the catholyte tank gas atmosphere, or a portion thereof.

In some embodiments, the gas atmosphere includes air (e.g., oxygen). In some embodiments, the gas atmosphere alternatively includes an inert gas (e.g., nitrogen, argon, etc.).

In some embodiments, the redox flow battery is a vanadium redox flow battery, a vanadium halide redox flow battery, a Fe—Cr redox flow battery, or a V—Fe redox flow battery.

In some embodiments, a method of operating a redox flow battery further includes operating the redox flow battery for a time sufficient to generate an amount of hydrogen in the anolyte tank and removing the hydrogen from the anolyte tank (e.g., by flowing a gas, such as air or an inert gas, over the anolyte). The inert gas can include, for example, argon or nitrogen.

These and other aspects of the present disclosure will become more evident upon reference to the following detailed description and attached drawings. It is to be understood, however, that various changes, alterations, and substitutions may be made to the specific aspects and embodiments disclosed herein without departing from their essential spirit and scope.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings.

FIG. 1 is a schematic illustration of a redox flow battery system with a barrier in the negative electrolyte tank according to an embodiment of the redox flow battery system.

FIG. 2 is a graph illustrating charged negative electrolyte state of charge (“SOC”) change when directly exposed to air.

FIG. 3 is a graph illustrating charged negative electrolyte SOC change at 20° C. and 50° C. when protected by oil, argon, or both oil and argon.

FIG. 4 is a graph illustrating negative electrolyte weight loss when directly exposed to air at 20° C.

FIG. 5 is a graph illustrating negative electrolyte weight loss when directly exposed to air at 50° C.

FIG. 6 is a graph illustrating the performance of a 1.3 kW all vanadium redox flow battery system using a barrier, such as, for example, an oil-covered negative electrolyte tank, according to an embodiment of the redox flow battery system.

### DETAILED DESCRIPTION

The present disclosure is directed to a flow electrochemical energy system that includes an electrochemical stack, or a plurality of electrochemical stacks, that are fluidically connected together. The flow electrochemical energy systems are described in the present disclosure in the context of an all-vanadium redox flow battery, wherein a V⁺/V²⁺ sulfate solution serves as the negative electrolyte (“anolyte”) and a V⁵⁺/V⁴⁺ sulfate solution serves as the positive electrolyte (“catholyte”).

It is to be understood, however, that other redox chemistries are contemplated and within the scope of the claimed subject matter, including V²⁺/V³⁺ vs. Br⁻/ClBr₂, Br₂/Br⁻ vs. S/S²⁻, Ce⁴⁺/Ce³⁺ vs. V²⁺/V³⁺, Fe³⁺/Fe²⁺ vs. Br₂/Br⁻, Mn²⁺/Mn³⁺ vs. Br₂/Br⁻, Fe³⁺/Fe²⁺ vs. Ti²⁺/Ti⁴⁺, etc. Table 1 provides some exemplary redox coupling reactions that can take place in a redox flow battery system.

TABLE 1

| Redox Couple Reaction | Standard Potential (V) |
|---|---|
| Cr³⁺/Cr²⁺ | −0.424 |
| V³⁺/V²⁺ | −0.255 |
| TiO²⁺/Ti³⁺ | −0.10 |
| H⁺/H₂ | 0.000 |
| Cu²⁺/Cu⁺ | 0.159 |
| VO²⁺/V³⁺ | 0.337 |
| Fe³⁺/Fe²⁺ | 0.771 |
| VO₂⁺/VO²⁺ | 1.000 |
| Br₂/Br | 1.087 |

In aqueous-based electrolyte solutions, the selection of redox couples is limited by the potentials of H₂ and O₂ gas evolution. To maximize the energy storage capacity, the potential difference of the positive redox couple and the negative redox couple should be as large as possible. As a result, the standard potential of the negative redox couple in a redox flow battery is lower than that of the O₂ reduction reaction (O₂+4H⁺+4e⁻=2H₂O, E_{O}=1.229 V), indicating the charged negative solution can be easily oxidized by air. Indeed, not only can charged negative electrolyte solutions be easily oxidized by oxygen in air, in some embodiments, the charged negative electrolyte solutions can be oxidized by H⁺ in the solution, which generates a small amount of H₂ as H⁺+ is reduced. The oxidation of charged negative electrolyte solutions can cause irreversible redox flow battery system capacity decay, and eventually lead to total capacity loss and redox flow battery damage.

To reduce the likelihood that the negative electrolyte solution would come into direct contact with air, embodiments of the negative electrolyte tanks disclosed herein can be filled with inert gas, such as argon (Ar) or nitrogen (N₂).

Furthermore, as discussed above, 2H⁺+2e⁻=H₂ has a relative high standard potential of 0.000 V compared to most redox couples in the redox flow battery. Thus, for most redox flow batteries, side reactions cannot be completely reduced, and undesired products such as H₂ can still be generated in the negative electrolyte tanks during regular battery charging operations. In some embodiments, to remove these side products and also to reduce the likelihood of oxidation of active charged species in the negative tanks, periodic purging of hydrogen from a headspace of the negative tank with a gas stream is conducted. Furthermore, purging can also reduce the accumulation of H₂ gas in the negative electrolyte tanks which can pose flammable/explosive hazard to the environment. However, purging can be expensive and can remove water from the redox flow battery, which can in turn change the concentration of the active species in the electrolytes.

Thus, there is still a need for new and improved flow electrochemical energy systems having reduced susceptibility to oxidation and related methods. The present disclosure fulfills these needs and provides for further related advantages.

### Redox Flow Batteries

Referring to FIG. 1, in general, a redox flow battery 10 includes an electrochemical cell 100, a catholyte tank 15 filled with liquid catholyte 20, and an anolyte tank 30 filled with liquid anolyte 35 and a gas atmosphere 37. Gas atmosphere 37 can occupy a headspace 62 above anolyte 35. Redox flow battery 10 operates by circulating catholyte 20 and anolyte 35 into electrochemical cell 100, which includes a cathode 40, an anode 42, and an ion transfer membrane 44 separating the cathode and the anode. Redox flow battery 10 can operate to either discharge or store energy as directed by power and control elements in electrical communication with electrochemical cell 100.

In one mode (sometimes referred to as the “charging” mode), power and control elements connected to a power element 50, operate to store electrical energy as chemical potential in catholyte 20 and anolyte 35. The power source can be any power source known to generate electrical power, include renewable power sources, such as wind, solar, and hydroelectric. Traditional power sources, such as combustion, can also be used.

In a second (“discharge”) mode of operation, redox flow battery 10 is operated to transform chemical potential stored in catholyte 20 and anolyte 35 into electrical energy that is then discharged on demand by power and control elements that supply an electrical load 50. FIG. 1 illustrates the flow of electrons (“e⁻”) through redox flow battery 10 in discharge mode. The operation of redox flow battery 10 in charging mode is essentially the opposite of operation in discharge mode.

Referring again to FIG. 1, redox flow battery 10 includes a conduit for gas entry (“an entry conduit”) 60 that leads into headspace 62 of anolyte tank 30, and a conduit for gas escape (“an exit conduit”) 64 that leads out from headspace 62 of anolyte tank 30. The conduit for gas entry conduit 60 can be attached to a pressurized tank (not shown) of air or an inert gas atmosphere (e.g., argon, nitrogen, etc.). The entry conduit 60 can have a closing and opening mechanism whereby the conduit is placed in the open or closed position, respectively, to allow or preclude gas flow, respectively.

During operation, the mechanism can open entry conduit 60 and allow gas to flow into and through entry conduit 64 and then into headspace 62. Simultaneously, a mechanism in exit conduit 64 can open the exit conduit so that gas entering headspace 62 can escape through exit conduit 64. In this way gas atmosphere 37 in headspace 62, which can contain hydrogen, is replaced with fresh atmosphere (e.g., air or an inert gas) which has less or no hydrogen content. The mechanisms in entry and exit conduits 60 and 64, respectively, can then close the conduits.

Alternatively, or additionally, a fan 66 can be placed in fluid communication with anolyte tank 30, for example, with headspace 62 of the anolyte tank. Fan 66 can be used to push fresh gas atmosphere into the headspace. For example, in the illustrated embodiment, a fan is located within the entry conduit, where that fresh gas atmosphere then exits through exit conduit 64. Alternatively or additionally, fan 66 can be used to pull fresh gas atmosphere into headspace 62 by being located within the exit conduit 64, such that fresh gas atmosphere is pulled into headspace 62 from the entry conduit 60. Once the fresh gas atmosphere has been pulled into headspace 62, conduits 60 and 64 can be closed so that atmosphere cannot flow freely through the headspace.

### Liquid or Solid Barrier

To reduce contact of anolyte 35 with gas atmosphere 37, anolyte 35 can be covered with a liquid or solid barrier 39 (e.g., a layer of oil, a polymer layer, etc.). Exemplary properties of the liquid or solid barrier are provided below.

Liquid or solid barrier 39 can be in direct contact with anolyte 35. In some embodiments, liquid or solid barrier 39 conforms to the surface of anolyte 35. The liquid or solid barrier can be relatively inert to chemical reactions, such as oxidation and reduction. In some embodiments, liquid or solid barrier 39 can be permeable to hydrogen, but impermeable to oxygen.

The solid barrier, in some embodiments, can include a polymer, such as synthetic or natural rubber, polyvinyl chloride, wax, and polyalkenes such as polyethylene and polypropylene. The solid barrier can be affixed (e.g., bonded) to the anolyte tank, or be free to move inside the anolyte tank. In some embodiments, the solid barrier floats on top of an anolyte in the anolyte tank. In some embodiments, the solid barrier forms a layer that covers at least a portion of the anolyte surface. In some embodiments, the solid barrier covers an entire surface of an anolyte.

In other embodiments, the liquid barrier may include an oil. In these embodiments, the oil forms a layer that covers at least a portion of the anolyte surface. In some embodiments, the oil covers an entire surface of an anolyte. Generally, oils having a melting point less than the melting point of the anolyte can be employed so that the oil is the liquid state when the anolyte is in the liquid state.

Various characteristics of the solid and liquid barrier can provide one or more benefits. For example, the liquid barrier can have low vapor pressure, such that the liquid barrier can remain on the anolyte surface for a long period of time with relatively little loss in volume. The solid or liquid barrier can have a relatively low density, when compared to the anolyte density, such that the solid or liquid barrier can float on the anolyte surface. The viscosity of the liquid barrier can be similar to the viscosity of the anolyte, such that the liquid and the anolyte can flow in a similar manner within the anolyte tank. The solid or liquid barrier can have a degree of oxygen resistance and/or acid resistance, such that the solid or liquid barrier can resist decomposition (e.g., by oxidation and/or by acid decomposition, etc.) within an anolyte tank environment.

In accordance with some embodiments of the present disclosure, the liquid barrier (e.g., a layer of oil, etc.) covering the anolyte has a boiling point greater than 50° C., 75° C., 100° C., 150° C., 200° C., or 250° C. In general, the boiling point of the liquid barrier is greater than the maximum operating temperature of the battery. In some embodiments, the maximum operating temperature is battery is typically 30° C., 35° C., 40° C., 45° C., or 50° C. In one embodiment, the boiling point of the oil is at least 25° C. greater than the maximum operating temperature of the battery, such that the vapor pressure of the oil is relatively low at the maximum operating temperature of the battery. A low vapor pressure for the oil is desirable because less of the oil is swept out of the headspace whenever the headspace is exposed to fresh gas atmosphere. As an example, mineral oil has a boiling point greater than 200° C., and is a suitable liquid barrier for use in the anolyte tank.

In some embodiments, the density of the solid or liquid barrier is less than the density of the anolyte so that the solid or liquid barrier floats on the surface of the anolyte. Generally, the density of the anolyte is at least 1 g/mL, and is typically greater than 1 g/mL depending on the identity and concentration of dissolved salts. In various embodiments, the solid or liquid barrier has a density of equal to or less than 1 g/mL, for example, 0.5-1 g/mL, 0.5-0.9 g/mL, or 0.6-0.9 g/mL, such that the solid or liquid barrier floats on the surface of the anolyte. As an example, mineral oil has a density of about 0.8 g/mL.

In some embodiments, the viscosity of the liquid barrier is approximately equal to the viscosity of the anolyte. For example, the viscosity of the liquid barrier can be within 10%, or 20%, or 30% of the viscosity of the anolyte.

The liquid or solid barrier covering the anolyte preferably has an oxidation resistance, also known as oxidative stability. Functional groups that are reactive with oxygen are preferably in relatively little amounts or absent from the liquid or solid barrier. For example, in some embodiments, the liquid barrier can be a saturated oil that lacks double or triple bonds between adjacent atoms. The liquid or solid barrier can be non-hydroxylated, i.e., lacking in hydroxyl groups.

The liquid of solid barrier covering the anolyte preferably has an acid resistance, also known as acid stability. Functional groups that are reactive with, or unstable in the presence of, aqueous acid are preferably in relatively little amounts or absent from the liquid or solid barrier. For example, in some embodiments, the liquid barrier can be a saturated oil that lacks double or triple bonds between adjacent atoms. The liquid or solid barrier can lack basic functional groups that can react with the acid.

Other characteristics of the liquid or solid barrier can be desirable in some embodiments of the present disclosure. For example, the liquid or solid barrier has a low water solubility such that the liquid or solid barrier is hydrophobic, or water-immiscible, or water-insoluble. The liquid or solid barrier can thus be easily separated from the anolyte during, for example, redox flow battery maintenance.

One example of a liquid barrier that can be used is mineral oil. The mineral oil may a saturated hydrocarbon having 15-40 carbons obtained as a distillate of petroleum, including one or more of straight chain, branched and cyclic hydrocarbons. Mineral oils are sometimes characterized as paraffinic oils when they are derived from n-alkanes, or as naphthenic oils when they are based on cycloalkanes. Either of those exemplary classes of mineral oil can be used. Mineral oils are available from many commercial suppliers, e.g., Aldrich Chemical Company (Milwaukee, Wis.) and Petro-Canada (Suncor Energy, Calgary, Canada).

Another example of a liquid barrier that can be used is a silicone oil. Silicone oil has a chemical structure that includes chains having alternating oxygen and silicon atoms, i.e., O—Si—O—Si, where the Si atoms are bonded to two other groups, e.g., methyl. In general, silicone oils display excellent thermal and oxidative stability. They are also non-flammable. Silicone oils are available in a wide range of viscosity, e.g., from 1-10,000 centistokes. Silicone oils are available from many commercial suppliers, e.g., Aldrich Chemical Company (Milwaukee, Wis.) and Dow-Corning (Midland, Mich.).

The amount of liquid or solid barrier which covers the anolyte can be selected to be an amount effective to reduce the oxidation of the anolyte when the liquid or solid barrier is placed as a layer between the anolyte and an oxygen-containing atmosphere, e.g., air. In some embodiments, the amount of liquid or solid barrier is generally selected so as to reduce the rate of anolyte oxidation, by, in various embodiments, 50% (i.e., if 70% of the V²⁺ is oxidized to V³⁺ in 10 hours in the absence of oil, then a 50% reduction in this rate means that it takes 15 hours to oxidize 70% of the V²⁺ to V³⁺); or 100%, or 150%, or 200%, or 250%, or 300%, or 350%, or 400% or more. The layer of oil covering the anolyte can have a thickness which, in exemplary embodiments, is at least 0.1 mm, or 0.5 mm, or 1 mm, or 10 mm, or 50 mm, or 100 mm, or 200 mm. For example, the thickness can be between 0.1 mm and 200 mm (e.g., between 3 mm and 50 mm, between 10 and 50 mm, between 10 and 100 mm, etc.).

The amount of liquid or solid barrier that covers the anolyte can be selected in view of the surface area of the anolyte that is exposed to the headspace and/or the total volume of the anolyte in the tank. In some embodiments, the amount of liquid or solid barrier utilized in combination with the anolyte is in an amount sufficient to completely cover the surface of the anolyte, such that the liquid or solid barrier can provide a complete physical barrier between the anolyte and the headspace. In this configuration, no gap between the sidewalls of the anolyte container and the liquid barrier is formed where oxygen may directly contact the anolyte in the area of the gap.

A ratio of the anolyte volume to the contact surface area, i.e., the area of the anolyte potentially in contact with the headspace, can be calculated for any particular tank configuration. In general, as the volume of the anolyte tank increases there is a corresponding increase in the ratio of the electrolyte volume to the contact surface area. A small flow battery system can have a ratio of the anolyte volume to the contact surface area of about 2.6 cm. For larger battery systems, this ratio can be much larger. In various embodiments, the anolyte is contained within a container that is designed to provide for a ratio of electrolyte volume to the contact surface area of greater than 2.6 cm, or greater than 10 cm, or greater than 100 cm, or greater than 1000 cm, or greater than 5000 cm.

In some embodiments, the redox flow battery further includes a catholyte tank that includes a catholyte and a catholyte tank gas atmosphere. The catholyte tank can include a liquid or solid barrier, or in some embodiments, does not include a liquid or solid barrier. In some embodiments, the liquid or solid barrier in the catholyte tank can be the same, or different from the liquid or solid barrier in the anolyte tank. The liquid or solid barrier in the catholyte tank can be employed in a similar manner as the liquid or solid barrier in the anolyte tank. For example, the liquid or solid barrier in the catholyte tank can be in direct contact with the catholyte. In some embodiments, the liquid or solid barrier in the catholyte tank conforms to the surface of the catholyte. In some embodiments, the liquid or solid barrier in the catholyte tank is employed to cover at least a portion of an interface between the catholyte and the catholyte tank gas atmosphere, such that the liquid or solid barrier in the catholyte tank can cover an entire interface between the catholyte and the catholyte tank gas atmosphere, or a portion thereof.

### Battery Operation

In operation, the anolyte is covered with a liquid or solid barrier to reduce contact of the anolyte with the atmosphere. The battery can be operated for a time sufficient to generate an amount of hydrogen in the headspace, and the headspace gas atmosphere that includes the amount of hydrogen can be replaced with fresh gas atmosphere.

Various non-limiting embodiments as disclosed herein are illustrated by the following non-limiting examples.

### Example 1

The exemplary system uses a V²⁺/V³⁺ sulfate-chloride solution at the anode side and a V⁴⁺/V⁵⁺+ sulfate-chloride solution at the cathode side, eliminating the cross-contamination effect between the electrolytes through the ion-exchange membrane. A standard voltage of 1.25 V is produced by the vanadium redox flow battery system through the following reactions:

[chemical structure]

An all-vanadium mixed acid redox flow battery system was used in this Example and all the electrolyte solutions were prepared electrochemically in flow cells using VOSO₄ and VOCl₂ mixture solution purchased from Bolong New Materials (Dalian, China). The flow cells used for small scale electrolyte preparation includes two graphite felt electrodes housed in two CPVC frames, two graphite current collectors, two Viton gaskets, and a Nafion® membrane. The graphite felts were oxidized in air at 400° C. for 6 hr to enhance electrochemical activity and hydrophilicity. The active area of the electrode and the membrane was about 48 cm². An Arbin battery tester was used to evaluate the performance of flow cells and to control the charging and discharging of the electrolytes. The flow rate was fixed at 96 mL/min, which was controlled by a peristaltic pump. The flow cell contained about 100 mL positive electrolyte and 50 mL negative electrolyte. Before the charging process, the negative electrolyte container was purged with 20 ml/min Ar for 15 min. The cell was charged at a current density of 80 mA/cm² to 1.6 V.

After charging, the negative electrolyte solution samples were exposed to air in 100 mL glass bottles at different temperatures, with or without the protection of mineral oil (from Aldrich Chemical Co., Milwaukee, Wis.). The electrolyte volume to solution-oil contact surface ratio for each sample was 2.6 cm. The V²⁺ and V³⁺ concentration in the electrolyte was measured periodically using a UV-Vis spectrometer. An environmental chamber was used to control the temperatures during tests. For weight loss experiments, the weight of treated samples was measured at fixed time intervals.

Like other charged active species in the negative electrolyte solutions of a redox flow battery, if directly exposed to air, the V²⁺ in the solution can be easily oxidized. In this Example, all the V²⁺ in the negative electrolyte was oxidized to V³⁺ within 24 hours. FIG. 2 shows the results at 20° C. and 50° C. State of Charge (SOC) is defined as the concentration ratio of V²⁺ to the sum of V²⁺ and V³⁺. The total vanadium concentration was 2.5 M. The oxidation rate was faster at high temperatures and with high starting V²⁺ concentrations. At 50° C., more than 70% of V²⁺ in the charged negative electrolyte was oxidized to V³⁺ within 5 hours.

When protected with a thin layer of oil, the stability of the charged negative electrolyte in air was greatly improved. As shown in FIG. 3, at 20° C., with 2.5 mm oil coverage, less than 10% SOC change was observed after 260 hours. The oxidation rate of V²⁺ electrolyte at 20° C. protected by Ar gas is also given in FIG. 3. Oil coverage showed better protection than Ar gas coverage. At 50° C., oil coverage can also largely decrease the electrolyte oxidation rate. A combination of oil coverage and Ar purge can dramatically decrease oxidation of the negative electrolyte solution. Less than 5% SOC decrease was observed after 240 hours at 50° C.

This protection method was further tested at 50° C. with varying thicknesses of oil coverage, and the results are given in Table 2. Again, thicker oil coverage did not further protect the electrolyte from getting oxidized. Compared to SOC change rate under 20° C., the SOC change rate at 50° C. is relatively larger. However, it is still much slower than that shown in FIG. 2.

The average reaction rate and normalized SOC change rate are also given in Table 2. The normalized SOC change rate is calculated according to the following equation:

$$Normalized SOC change rate = \frac{SOC change}{[ expose time * ( electrolyte volume / oil contact area ) ]}$$

TABLE 2
SOC change rate of oil-covered all vanadium mixed acid redox
flow battery negative electrolyte solution at 50° C.

| | Covered w/ | Covered w/ |
|---|---|---|
| | 2.6 mm oil | 10.4 mm oil |
| Starting SOC, % | 80.5 | 80.5 |
| SOC after 240 hr, % | 54.6 | 57.0 |
| Average SOC change rate, %/hr | 0.054 | 0.049 |
| Normalized SOC change rate, %/hr-m | 0.0014 | 0.0013 |

### Example 2

Due to the relative high standard potential of reaction 2H⁺+2e⁻=H₂ (E_{O}=0.000 V) compared to the standard potential of the redox couple V²⁺/V³⁺, there is a small amount of H₂ generation during redox flow battery operations. Also most charged species in the negative electrolyte solutions of redox flow batteries are thermodynamically unstable in acidic solutions. For all vanadium redox flow batteries, under normal operating conditions, a small amount of V²⁺ can be oxidized by H⁺ in the solution via the chemical reaction:

V²⁺+2H⁺→V³⁺+H₂.

The generated H₂ gas can accumulate in the negative electrolyte tanks and eventually pose flammable/explosive hazard to the environment. To reduce hazardous conditions, a periodic inert gas purge is generally required to keep the H₂ level in the negative tank below a desired limit (˜4%). This operation can be expensive and can remove a significant amount of water out of the system and changes the concentration of the active species in the electrolytes. Accordingly, periodic water make-up or water-saturated inert gas purging is required to maintain stable, long-term performance of the system.

Using covering oil in the negative electrolyte tanks can effectively reduce water-loss during H₂-purging operation. FIGS. 4 and 5 show the electrolyte weight loss at 20° C. and 50° C., respectively, with a 2.6 mm or 10.4 mm layer of oil on the surface, or without covering oil on the surface. The sample bottles were directly open to air without active gas purging. At 20° C., less than 0.01% weight loss was observed for the two oil-covered samples after being directly open to the air for 382 hr, whereas more than 5% weight loss was observed for the non-covered sample for the same time period. At 50° C., more than 33% weight loss was observed for the non-covered sample after 100 hr. However, for the two oil-covered samples, the weight loss was less than 0.5% after 382 hr. Here, the electrolyte volume to oil contact surface ratio was 2.6 cm. For the large systems, the electrolyte volume to oil surface ratio will be much larger than 2.6 cm, indicating the water make-up operation can be simplified, if not omitted, for the oil-covered systems.

### Example 3

A 1.3 kW all vanadium mixed acid redox flow battery system was used to validate the effectiveness of the oil-covering protection method. This system included of one 15-cell stacks, and two 20-gallon electrolyte tanks, each containing about 10 gallons of electrolyte solution. The active area of each cell was 875 cm². DuPont Nafion 115 membrane was used in the stack. The stack performance test was carried out at around 38° C.

The oil-covering negative electrolyte protection method was applied to a 1.3 kW all vanadium mixed acid redox flow battery system. FIG. 1 gives a schematic illustration of this system (for clarity, only one cell is shown here). It included of one 1.3 kW 15-cell stack, and two 20-gallon tanks, each containing about 10 gallons of electrolyte solution. The surface of the negative electrolyte solution was covered by about 10 mm mineral oil. The negative tank was directly exposed to air and was purged periodically by a small air pump to remove small amount of H₂ out of the tank. FIG. 6 shows the performance of this system. Very stable performance was achieved over an extended period of operation, indicating that, even with periodic air purge, the air oxidation reaction of the negative electrolyte solution was successfully minimized by the covering oil. A 1.3 kW all vanadium flow battery system using an oil protection system showed very stable performance for more than 200 cycles.

Unless otherwise defined, all technical and scientific terms used herein have the same meaning as commonly understood by one of ordinary skill in the art. Although methods and materials similar or equivalent to those described herein can be used in the practice or testing of the present disclosure, suitable methods and materials are described herein. All publications, patent applications, patents, and other references mentioned herein are incorporated by reference in their entirety. In case of conflict, the present specification, including definitions, will control. In addition, the materials, methods, and examples are illustrative only and not intended to be limiting.

While the present disclosure has been described in the context of the embodiments illustrated and described herein, the disclosure may be embodied in other specific ways or in other specific forms without departing from its spirit or essential characteristics. Therefore, the described embodiments are to be considered in all respects as illustrative and not restrictive. The scope of the disclosure is, therefore, indicated by the appended claims rather than by the foregoing description, and all changes that come within the meaning and range of equivalency of the claims are to be embraced within their scope.

1. A redox flow battery comprising an anolyte tank comprising an anolyte having a surface, a gas atmosphere, and a first liquid or solid barrier between the anolyte and the gas atmosphere, wherein the first liquid or solid barrier is in direct contact with the surface of the anolyte.

2. The redox flow battery of claim 1, further comprising a catholyte tank comprising a catholyte and a catholyte tank gas atmosphere, wherein the catholyte tank does not comprise a liquid or solid barrier.

3. The redox flow battery of claim 1, further comprising a catholyte tank comprising a catholyte, a catholyte tank gas atmosphere, and a second liquid or solid barrier between the catholyte and the catholyte tank gas atmosphere, wherein the second liquid or solid barrier is in direct contact with the surface of the catholyte.

4. A redox flow battery comprising:
(a) an anolyte tank comprising an anolyte having a surface, a gas atmosphere, and a first liquid or a solid barrier between the anolyte and the gas atmosphere, wherein the first liquid or the solid barrier is in direct contact with the surface of the anolyte;
(b) an anode in fluid communication with the anolyte tank;
(c) a catholyte tank comprising a catholyte;
(d) a cathode in fluid communication with the catholyte tank; and
(e) an ion-permeable separator between the cathode and the anode.

5. The redox flow battery of claim 1, wherein the first liquid or solid barrier covers at least a portion of an interface between the anolyte and the gas atmosphere.

6. The redox flow battery of claim 1, wherein the first liquid or solid barrier covers an entire interface between the anolyte and the gas atmosphere.

7. The redox flow battery of claim 1, wherein the first liquid or solid barrier is in the form of a layer.

8. The redox flow battery of claim 7, wherein the layer has a thickness of from 0.1 to 200 mm.

9. The redox flow battery of claim 1, wherein the first liquid or solid barrier is hydrogen permeable.

10. The redox flow battery of claim 1, wherein the first liquid or solid barrier is oxygen impermeable.

11. The redox flow battery of claim 1, wherein the anolyte tank comprises a first liquid barrier between the anolyte and the gas atmosphere.

12. The redox flow battery of claim 1, wherein the first liquid barrier comprises an oil.

13. The redox flow battery of claim 1, wherein the oil comprises an organic oil.

14. The redox flow battery of claim 12, wherein the oil is saturated.

15. The redox flow battery of claim 12, wherein the oil is non-reactive.

16. The redox flow battery of claim 12, wherein the oil is selected from the group consisting of silicone oil and mineral oil.

17. The redox flow battery of claim 1, wherein the gas atmosphere comprises air.

18. The redox flow battery of claim 1, wherein the gas atmosphere comprises oxygen.

19. The redox flow battery of claim 1, wherein the gas atmosphere comprises an inert gas.

20. The redox flow battery of claim 19, wherein the inert gas comprises nitrogen or argon.

21. The redox flow battery of claim 1, comprising one of a vanadium redox flow battery, a vanadium halide redox flow battery, a Fe—Cr redox flow battery, or a V—Fe redox flow battery.

22. The redox flow battery of claim 21, comprising a vanadium redox flow battery.

23. A method of operating a redox flow battery, comprising:
(a) providing a redox flow battery comprising an anolyte tank comprising an anolyte and a gas atmosphere; and
(b) providing a liquid or solid barrier between the anolyte and the gas atmosphere, wherein the liquid or solid barrier is in direct contact with the surface of the anolyte; and
(c) operating the redox flow battery.
